(19) United States
(12) Patent Application Publication
(10) Pub. No.: US 2002/0138508 A1
(43) Pub. Date: Sep. 26, 2002

(54) Document processing systems with scanning review capability

(76) Inventors: Alejandro Wiechers, Jalisco (MX); Gustavo M. Guillemin, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/816,816

(22) Filed: Mar. 22, 2001

(51) Int. Cl. G06F 15/00

(52) U.S. Cl. 707/500

(57) ABSTRACT

A document processing system provides information corresponding to a scanned document. Preferably, the document processing system includes a scan review system that is configured to receive scan information corresponding to a scanned document. The scan review system enables selection of a registration characteristic of a page of a document to be scanned. Once the registration characteristic is selected, the document may be reviewed relative to the selected registration characteristic. So configured, in response to identifying a page of the document as not possessing the selected registration characteristic, the scan review system may designate that page(s) for review. Methods and computer readable media also are provided.

### BACKGROUND OF THE INVENTION

1. Field of the Invention

The present invention generally relates to document processing and, in particular, to systems and methods for scanning documents that are capable of facilitating review of one or more of the pages of a document to be scanned during a scanning operation.

2. Description of the Related Art

As is known, scanning of a document, i.e., converting printed information of a document into an electronic format via a scanning device, typically is a labor intensive process. For instance, when a book is to be scanned, the pages of the book typically are manually checked in order to ensure that all of the pages are provided and that all of the provided pages are in the proper order. Additionally, after the pages of the book have been scanned, oftentimes, scan information corresponding to the scanned pages is checked to ensure that all of the pages of the book were properly scanned and that the scan information is in the proper order, e.g., page number order.

Since scanning of documents may entail the aforementioned, as well as potentially other labor intensive processes, much effort has been devoted to attempting to automate at least portions of a scanning process. Heretofore, however, these attempts have met with relatively little success.

Therefore, there is a need for improved systems and methods that address these and/or other shortcomings of the prior art.

### SUMMARY OF THE INVENTION

Briefly described, the present invention generally relates to document processing. In this regard, embodiments of the invention may be construed as providing document processing systems for providing information corresponding to a scanned document. In a preferred embodiment, the document processing system includes a scan review system that is configured to receive scan information corresponding to a scanned document. The scan review system enables selection of a registration characteristic of a page of a document to be scanned. Once the registration characteristic is selected, the document may be reviewed relative to the selected registration characteristic. So configured, in response to identifying a page of the document as not possessing the selected registration characteristic, the scan review system may designate the page(s) for review. For instance, in some embodiments, such a review may be facilitated by an operator viewing information corresponding to the designated page that is displayed via a graphical user interface.

Other embodiments of the invention may be construed as providing methods for providing information corresponding to a scanned document. In this regard, a preferred embodiment includes the steps of: (1) enabling selection of a registration characteristic of a page of the document; (2) reviewing pages of the document relative to the selected registration characteristic; and (3) enabling receipt of scan information corresponding to the pages of the document. In some embodiments, the registration characteristic may be selected from top line, top margin, bottom line, bottom margin, left margin, right margin, and page number of a page, among others.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a preferred embodiment of the document processing system of the present invention.

FIG. 2 is a flowchart depicting functionality of the document processing system of FIG. 1.

FIG. 3 is a schematic diagram of a computer of processor-based system which may be utilized to implement the scan review system of FIG. 1.

FIG. 4 is a flowchart depicting functionality of the embodiment of the scan review system shown in FIG. 3.

FIG. 5 depicts a representative graphical user interface that may be implemented by the scan review system of FIG. 3.

FIG. 6 is a screen print of the graphical user interface depicted in FIG. 5, showing an improperly registered page.

FIG. 7 is a flowchart depicting functionality of an embodiment of the scan review system of FIG. 3.

### DETAILED DESCRIPTION OF THE PREFERRED EMBODIMENT

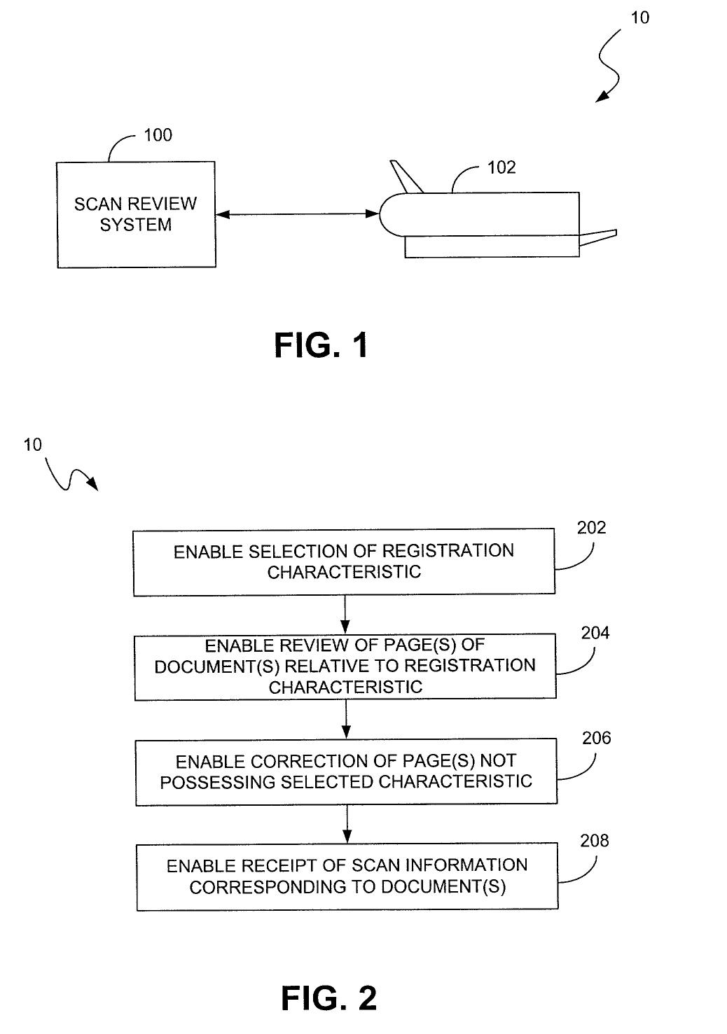

As shown in FIG. 1, a preferred embodiment of the document processing system 10 of the present invention includes a scan review system 100. Scan review system 100 communicates with at least one scanner 102 that is adapted to convert printed information of a document into a digital format. So provided, scanner 102 is able to scan one or more pages of a printed document(s) and provide scan information corresponding to the one or more pages to the scan review system 100.

Functionality of a preferred embodiment of the document processing system 10 is depicted in the flowchart of FIG. 2. It should be noted that any process description(s) or block(s) presented in flowcharts herein may be construed, in some embodiments, as representing modules, segments, or portions of code which include one or more executable instructions for implementing specific logical functions or steps in the process. Alternative implementations, however, also are provided wherein the functions or steps may be executed out of order from that shown or discussed, including substantially concurrently or in reverse order, depending on the functionality involved, as would be understood by those reasonably skilled in the art of the present invention.

As depicted in FIG. 2, the document processing system or method 10 may be construed as beginning at block 202 where selection of a registration characteristic is enabled. By way of example, such a registration characteristic may include page number, top line, bottom line, left side margin, right side margin, or any other feature(s) of a page to be scanned that may be utilized for determining proper alignment of the page relative to the scanner. In block 204, review of the page(s) to be scanned relative to the selected registration characteristic may be facilitated. For instance, assuming that the registration characteristic of the top line has been selected, review of the pages to be scanned may include determining whether the top line of each page is appropriately positioned for scanning, e.g., whether the top line of each page is properly positioned relative to one or more components of the scanner so that a proper scanned image corresponding to the page may be acquired.

Determining whether a page is properly registered relative to a scanner may become increasingly important as multiple pages are to be scanned. More specifically, if a page is not properly registered, the ability of the scanner to acquire image data from the page may be inhibited as a portion of the printed information may not be viewable (acquirable) by the scanner. Such a situation may occur when the page is not properly provided to the scanning portion or bed of the scanner by an automatic document feeder (ADF), for example. When multiple pages are to be consecutively scanned, improper page registration may lead to improper image acquisition of multiple pages, and/or may be a precursor to a malfunction, such as a paper jam of the ADF or ADF equipment failure, for example.

Proceeding to block 206, correction of the page(s) not properly exhibiting the selected registration characteristic is enabled. For instance, if, during the review of a page, it is determined that the registration characteristic of that page does not correspond, e.g., is not properly aligned, with the selected registration characteristic, correction of the page may be facilitated. In some embodiments, enabling correction of the page(s) may include providing an operator with an indication that the page(s) is not properly registered. Thus, in response to receiving such notification, the operator may attempt to properly register the page at that time so that the scanning process may continue. In other embodiments, the scanning process may continue, e.g., scanning of subsequent pages may be initiated, and the improperly registered page may be designated for review and/or scanning at a later time.

In block 208, receipt of scan information corresponding to the scanned page(s) of the document(s) is enabled. As described in greater detail hereinafter, scan information associated with a particular document, e.g., a book, may be provided in an e-file format so as to be conveniently displayable and/or printable via a command from a personal computer, viewing device, etc.

Document processing systems and, more specifically, scan review systems of the present invention may be implemented in hardware, software, firmware, or a combination thereof. In a preferred embodiment, however, the scan review system is implemented as a software package, which can be adaptable to run on different platforms and operating systems, in combination with a set of hardware and shall be described further herein. More specifically, a preferred embodiment of the scan review system, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable, programmable, read-only memory (EPROM or Flash memory) (magnetic), an optical fiber (optical), and a portable compact disk read-only memory (CDROM) (optical). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

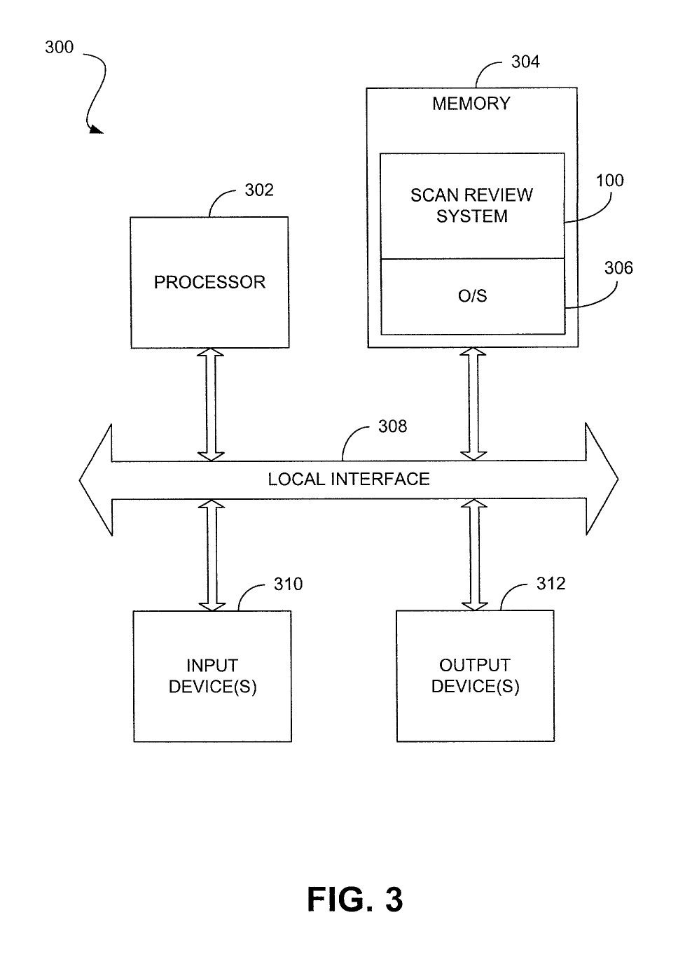

FIG. 3 illustrates a computer or processor-based system 300 which may facilitate the scan review system of the present invention, e.g., scan review system 100 (FIG. 1). As shown in FIG. 3, computer system 300 generally comprises a processor 302 and a memory 304 with an operating system 306. Herein, the memory 304 may be any combination of volatile and nonvolatile memory elements, such as random access memory or read only memory. The processor 302 accepts instructions and data from memory 304 over a local interface 308, such as a bus(es). Computer system 300 also includes any number of input device(s) 310, output device(s) 312, and/or input/output devices (not shown). Examples of input devices may include, but are not limited to, a serial port and/or a local access network connection. Examples of output devices may include, but are not limited to, a Universal Serial Bus and/or a local access network connection. Generally, this system may run any of a number of different platforms and operating systems, including, but not limited to, HP-UX™, Linux™, Unix™, Sun Solaris™ or Windows NT™ operating systems. The scan review system, the functions of which shall be described hereinafter, resides in memory 304 and is executed by the processor 302. It should be noted that one or more processor-based systems, such as the processor-based system depicted in FIG. 3, for example, may be utilized to facilitate the functionality described hereinafter, with the one or more processor-based systems being communicatively coupled, e.g., in a network environment, so that the systems may cooperate to provide the various functions.

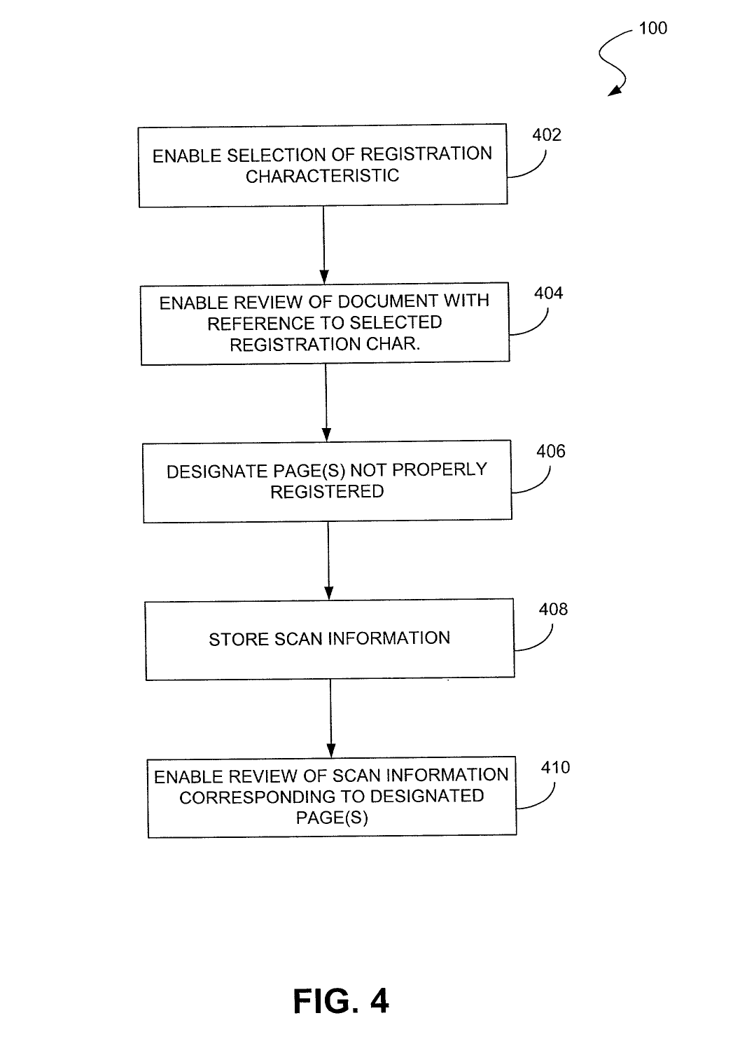

The flowchart of FIG. 4 shows the functionality of a preferred implementation of the scan review system 100. As depicted in FIG. 4, scan review system or method 100 may be construed as beginning at block 402 where selection of a registration characteristic(s) is enabled. In block 404 review of a page(s) of a document(s) with reference to the selected registration characteristic is enabled. Thereafter, such as depicted in block 406, pages not properly registered may be designated as possessing a potential scan problem. By way of example, scan information corresponding to a page not properly registered may be marked, such as with a code or flag, for example, so that scan information corresponding to that page may be later identified as being associated with a page that potentially encountered problems during the scanning process. In those embodiments configured to review pages relative to page number, the aforementioned review and designation steps (blocks 404 and 406) may include determining whether a page(s) is missing and/or out of page number order, and then designating the page as being missing and/or out of page number order, as appropriate. Scan information then may be stored (block 408).

In block 410, review of scan information may be enabled. In particular, review of scan information corresponding to pages previously designated as potentially possessing a scan-related problem may be enabled. For example, in some embodiments, the acquired image corresponding to a designated page may be displayed to an operator. During such a review, an operator may readily identify pages that may require re-scanning. For those pages that are designated as missing and/or out of page number order, review of information associated with these pages also may be enabled.

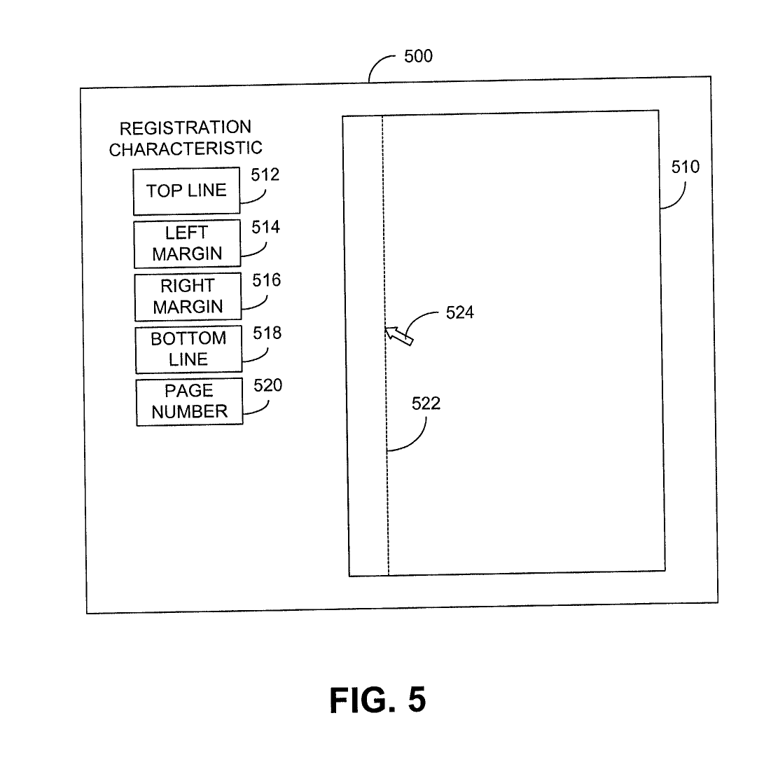

As mentioned hereinbefore, the scan review system 100 may facilitate selection and utilization of a registration characteristic(s). In this regard, reference will now be made to FIG. 5, which depicts a representative graphical user interface (GUI) 500 that may be utilized to facilitate selection of such a registration characteristic. As shown in FIG. 5, GUI 500 incorporates a page viewing field 510 within which image data corresponding to a scanned page may be displayed. For instance, image data corresponding to scanned pages may be provided within page viewing field 510 during a review process.

GUI 500 also provides an operator with the ability to select one or more registration characteristics that are to be utilized during a scanning process. In the embodiment depicted in FIG. 5, multiple icons are provided, with each icon being associated with a particular registration characteristic. For example, icon 512 is depicted as being associated with the top line of a page, icon 514 with the left margin, icon 516 with the right margin, icon 518 with the bottom line, and icon 520 with the page number, although various other characteristics may be utilized. Selection of a particular characteristic may be facilitated by actuating the icon corresponding to the desired characteristic.

By way of example, if an operator has determined that selection of the left margin as a registration characteristic is appropriate for a particular scanning operation, the operator may select the left margin by actuating icon 514. In response thereto, reference line 522, which corresponds to a left margin, may be displayed in viewing window 510. The operator may then position reference line 522, in some embodiments, such as by dragging the line in a conventional manner, e.g., by utilizing cursor 524. Positioning of the reference line, or other registration characteristic, may be based upon the anticipated margin width and/or other characteristics of the page or pages to be scanned, as appropriate. In some embodiments, a default or an automatically selected placement of a reference line or characteristic indicia may be provided.

Positioning of such a reference line or characteristic indicia may be facilitated after a reference page has been provided to the scanner for scanning, such as by an automatic document feeder. Preferably, the page is positioned in what is considered to be an appropriate position for scanning, so that an assessment may be made by the operator as to which registration characteristic is appropriate for utilization by the scan review system.

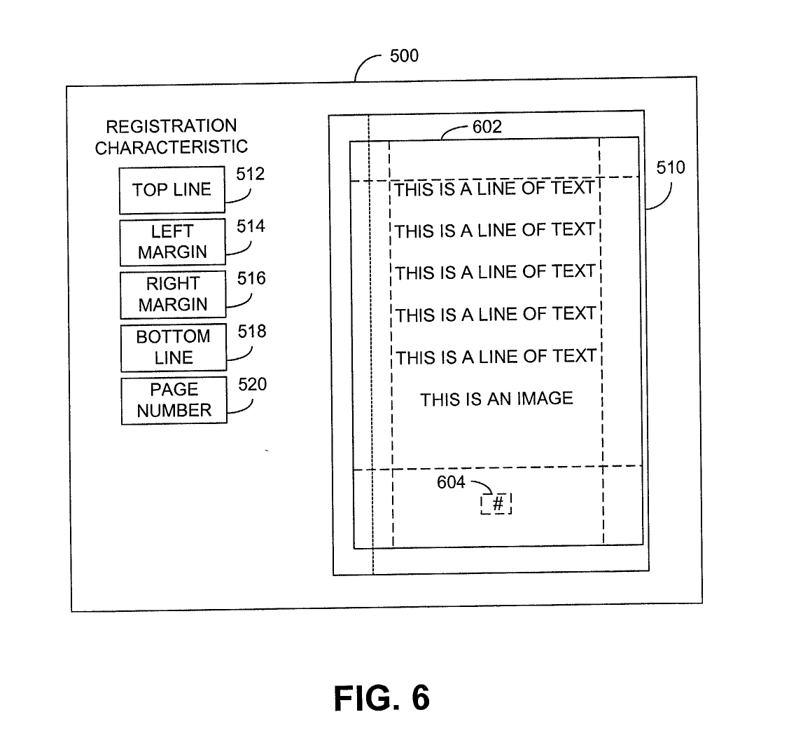

Referring now to FIG. 6, a representative page to be scanned, e.g., page 602, has been provided to a scanner (not shown) associated with the scan review system. As depicted in FIG. 6, it is to be assumed that page 602 has been scanned, with image data corresponding to page 602 being displayed in field 510. Based upon the selected registration characteristic of a left margin (described in relation to FIG. 5), page 602 has been provided to the scanner in an improper position, e.g., the left margin of page 602 is not properly aligned with reference line 522. Thus, scan information associated with page 602 may be designated as potentially possessing a problem, as described hereinbefore.

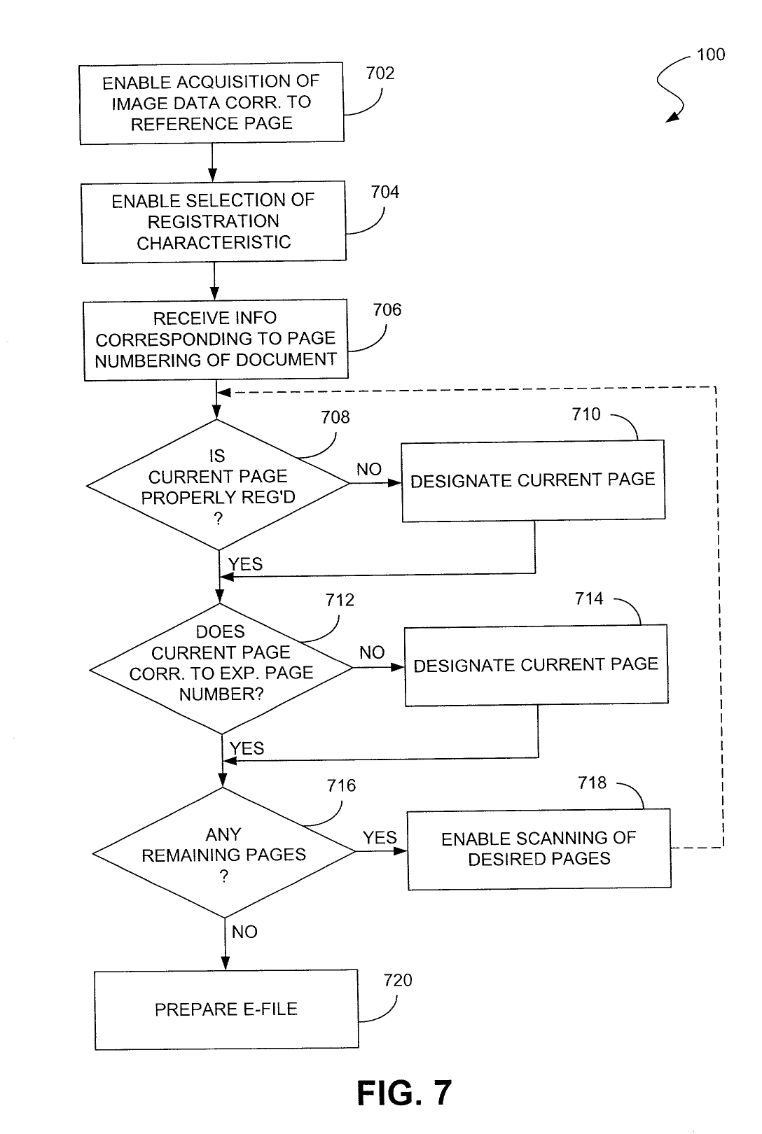

Reference will now be made to the flow chart depicted in FIG. 7, which depicts functionality of an alternative embodiment of the scan review system 100. As depicted in FIG. 7, scan review system or method 100 may be construed as beginning at block 702 where acquisition of image data corresponding to a reference page is enabled. In block 704, selection of a registration characteristic(s) is enabled. Thereafter, such as in block 706, information corresponding to page numbering of a document(s) to be scanned is received. More specifically, information corresponding to the number of pages to be scanned preferably is received. In block 708, a determination may be made as to whether the page currently provided for scanning is properly registered. If it is determined that the current page is not properly registered, the process may proceed to block 710 where information corresponding to the current page may be designated, such as by marking. Thereafter or, alternatively, if the determination was made that the current page was properly registered, the process may proceed to block 712. As depicted in block 712, a determination may be made as to whether the current page corresponds to the expected page number. For instance, if, such as in block 706, information was received that indicated that 200 pages were to be scanned and 199 pages previously have been scanned, the determination would regard whether the current page corresponds to page number 200.

In order to determine the page number associated with a given page, embodiments of the scan review system of the present invention may acquire image data associated with the page number. This image data then may be processed, such as by optical character recognition (OCR). The information corresponding to the page number of a particular page then may be compared to the information received regarding the page numbering of the document.

The ability of embodiments of the scan review system to identify particular printed information as being associated with a page number of a page to be scanned may be attributed to identifying an expected location of the page number, such as bottom center, bottom left, etc. In some embodiments, identifying a particular location for page number placement may be facilitated by a graphical user interface, such as the GUI depicted in FIG. 6, for example. For instance, by selecting the page number icon 520, the operator may be provided with a moveable field 604, represented by dashed lines. Field 604 may be positioned where page number information is expected to be present among the various pages of a document to be scanned. By way of example, the field may be positioned by utilizing a conventional drag methodology, described hereinbefore in relation to positioning reference line 522. Thus, once appropriately positioned, a page number appearing within filed 604 may be processed by OCR and then utilized to determine whether the current page corresponds to the expected page number during the scanning process.

Referring back to block 712 of FIG. 7, if it is determined that the current page number does not correspond to the expected page number, the process may proceed to block 714 where the current page may be designated, e.g., designated as potentially possessing a scan problem. Thereafter or, alternatively, if it was determined that the current page number corresponds to the expected page number, the process may proceed to block 716. As depicted in block 716, a determination may be made as to whether any pages remain to be scanned. If it is determined that there are pages remaining, the process may proceed to block 718 where scanning of desired pages is enabled. In particular, previously unscanned pages may be scanned. Additionally, the operator may review information corresponding to the scanned pages and determine whether particular ones of the pages may need to be rescanned. These documents to be rescanned may include pages previously designated as potentially possessing scan errors, such as described hereinbefore in relation blocks 710 and 714, for example. In regard to documents that are to be rescanned, the process may return to block 708 and proceed as described hereinbefore. If, however, it was determined in block 716 that pages do not remain to be scanned, the process may proceed to block 720 where scan information may be prepared, such as in the form of an e-file, for example.

In some embodiments, the scan review system may prepare or generate multiple files associated with each page scanned. In particular, the scan review system may generate two linked files, with one of the files containing page content information and the other of the files containing page number information. So provided, the scan review system may be configured to track those page numbers associated with pages scanned and/or compile the scanned information associated with the various scanned pages in page number order, for example. In some embodiments, review of the information provided to the scan review system may be conveniently facilitated by a conversion report that is provided for review by the operator. In some embodiments, such a conversion report may include information pertaining to a document, e.g., a book, that is to be scanned. In these embodiments, the conversion report may include a representation of the book title, number of pages, missing pages, and/or misplaced pages, among others. This information may be displayed to an operator via the GUI 500 depicted in FIGS. 5 and 6, for example. Thus, the operator may readily identify pages that were not scanned during the scanning operation and/or pages that were not properly ordered, e.g., in page number order, during the scanning process.

As mentioned hereinbefore, pages not appearing in the proper order during scanning may not necessarily disrupt the scanning operation, as some embodiments of the scan review system may automatically compile scan information associated with the misplaced pages in the proper order. So provided, an operator may only have to scan pages identified as being missing and then adding scan information corresponding to the missing pages to the e-file associated with the scanned document.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

1. A document processing system for providing information corresponding to a scanned document, said document processing system comprising:
a scan review system configured for receiving scan information corresponding to a scanned document, said scan review system being configured to enable selection of a registration characteristic of a page of a document to be scanned and review the document to be scanned relative to the selected registration characteristic such that, in response to identifying a page of the document as not possessing the selected registration characteristic, said scan review system designates the page for review.

2. The document processing system of claim 1, further comprising:
a scanner communicatively coupled to said scan review system, said scanner being configured to receive the document to be scanned and convert printed information of each page of the document into scan information, the scan information being provided in an electronic format to said scan review system.

3. The document processing system of claim 1, wherein said scan review system is configured to provide a graphical user interface, said graphical user interface being configured to enable selection of the registration characteristic.

4. The document processing system of claim 1, wherein said scan review system comprises means for enabling selection of the registration characteristic.

5. The document processing system of claim 1, wherein the registration characteristic is at least one of: top line, top margin, bottom line, bottom margin, left margin, right margin, and page number.

6. The document processing system of claim 1, wherein said scan review system is configured to determine a page number of each page of a document to be scanned and to designate scan information corresponding to pages of the document that are not scanned in page order.

7. The document processing system of claim 1, wherein said scan review system comprises:
means for determining a page number of each page of a document to be scanned; and
means for designating scan information corresponding to pages of the document that are not scanned in page order.

8. The document processing system of claim 1, wherein said scan review system is configured to generate two files associated with each page of a document to be scanned, a first of said files containing page content information and a second of the files containing page number information, said scan review system being further configured to utilize the page number information to arrange the page content information in page number order.

9. The document processing system of claim 1, wherein said scan review system is embodied on a computer readable medium.

10. The document processing system of claim 3, wherein said graphical user interface provides a page viewing window configured to display therein scan information corresponding to a page of the document to be scanned.

11. The document processing system of claim 9, wherein said scan review system comprises logic configured to designate pages of the document that were not scanned in page order.

12. The document processing system of claim 10, wherein said graphical user interface is configured to provide an operator with information indicating the pages of the document that were not scanned in page order.

13. The document processing system of claim 10, wherein said graphical user interface provides a page number field, said page number field being moveable by an operator about said page viewing window such that a location corresponding to a page number of a page to be scanned may be designated, and wherein said scan review system is configured to process scan information located in a vicinity of said page number field to determine the page number of the page.

14. A method for providing information corresponding to a scanned document comprising the steps of:
enabling selection of a registration characteristic of a page of the document;
reviewing pages of the document relative to the selected registration characteristic; and
enabling receipt of scan information corresponding to the pages of the document.

15. The method of claim 14, wherein the step of reviewing comprises designating pages not properly exhibiting the selected registration characteristic.

16. The method of claim 14, further comprising the steps of:
determining whether a current page of the document to be scanned corresponds to an expected page number; and
if the current page number does not correspond to the expected page number, designating the current page for review.

17. The method of claim 14, further comprising the step of preparing an e-file corresponding to the document to be scanned.

18. The method of claim 14, wherein the registration characteristic is at least one of: top line, top margin, bottom line, bottom margin, left margin, right margin, and page number.

19. The method of claim 17, wherein the step of preparing an e-file comprises the steps of:
generating, for each page scanned, a first file containing page content information;
generating, for each page scanned, a second file containing page number information, each second file being associated with a respective first file; and
utilizing the second files so as to arrange the page content information of the first files in page number order.

20. The method of claim 19, further comprising the steps of:
identifying pages missing from the e-file;
scanning the missing pages; and
providing page content information associated with the missing pages to the e-file such that the page content information is arranged in page number order.
